(19) United States
(12) Patent Application Publication
(10) Pub. No.: US 2012/0094791 A1
(43) Pub. Date: Apr. 19, 2012

(54) ISOLATION DAMPER PULLEY FOR VEHICLE

(75) Inventor: Byungsik Lee, Daegu (KR)

(73) Assignees: Kia Motors Corporation, Seoul (KR); Hyundai Motor Company, Seoul (KR)

(21) Appl. No.: 13/185,252

(22) Filed: Jul. 18, 2011

(30) Foreign Application Priority Data
Oct. 15, 2010 (KR) 10-2010-0101058

(51) Int. Cl. F16F 15/12; F16H 55/36

(52) U.S. Cl. 474/94

(57) ABSTRACT

A damper pulley for a vehicle may include a damper portion connected to a crankshaft, a pulley portion connected to the damper portion, and a bearing portion disposed between the damper portion and the pulley portion, wherein the bearing portion includes a first bearing supporting a load applied in an axial direction and a second bearing supporting a load applied in a direction perpendicular to the axial direction, and the first and second bearings are engaged through protrusions and depressions.

### CROSS-REFERENCE TO RELATED APPLICATION

This application claims priority to and the benefit of Korean Patent Application No. 10-2010-0101058 filed Oct. 15, 2010, the entire contents of which application is incorporated herein for all purposes by this reference.

### BACKGROUND OF INVENTION

1. Field of Invention

The present invention relates to a vehicle. More particularly, the present invention relates to a damper pulley that reduces twist vibration of an engine crankshaft and a speed variation transferred to a pulley.

2. Description of Related Art

Currently, the importance of sensitivity is being magnified due to innovative progress of vehicle development techniques, and more particularly, attempts to reduce noise, vibration, and harshness (NVH) of a vehicle are being actively undertaken.

As a representative method among these, a damper pulley (called an “isolation damper pulley”) reduces torsional vibration of a crankshaft of an engine and an angular speed variation transferred to a pulley through a damping rubber, and improves the lifespan of an auxiliary belt.

The damper pulley is divided into a damper portion and a pulley portion, and a journal bearing and a thrust bearing are disposed between the damper portion and the pulley portion so as to prevent friction and noise therebetween.

The journal bearing and the thrust bearing are assembled by a welding method in the conventional art.

That is, after the thrust bearing is welded onto the pulley portion, the damper portion together with the journal bearing are forcibly fitted into the pulley portion, or after the journal bearing is welded onto the thrust bearing, it is forcibly fitted onto the pulley portion together with the damper portion.

However, since the journal bearing and the thrust bearing are assembled through a welding process so as to assemble the damper portion and the pulley portion in a conventional art, the assembly cost is increased and the damper pulley can be damaged by faulty welding.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a damper pulley for a vehicle having advantages of preventing friction and noise between the damper portion and the pulley portion without a welding process of the journal bearing and the thrust bearing.

In various aspects, the damper pulley for a vehicle may include a damper portion connected to a crankshaft, a pulley portion connected to the damper portion, and a bearing portion disposed between the damper portion and the pulley portion, wherein the bearing portion includes a first bearing supporting a load applied in an axial direction and a second bearing supporting a load applied in a direction perpendicular to the axial direction, and the first and second bearings are engaged through protrusions and depressions.

The first and second bearings may be disposed to be separated from each other.

One of the first and second bearings may be engaged with the other through protrusions and depressions of a flange type.

A plurality of engagement protrusions may be formed at one of the first and second bearings along the circumference direction.

A plurality of engagement grooves may be formed at the other to be engaged with the engagement protrusions.

The bearing portion may be press-fit into the pulley portion together with the damper portion.

The first bearing may have a cylinder shape having a predetermined length.

The second bearing may have a flat ring shape having a predetermined width.

The second bearing may be disposed outside the first bearing based on a concentric circle, and protrusions and depressions of the second bearing are engaged with one side end portion of the first bearing.

A plurality of engagement protrusions may be arranged at a predetermined distance from each other along an inner edge of the second bearing.

A plurality of engagement grooves may be arranged along one side end portion of the first bearing to be engaged with the engagement protrusion.

The first bearing may be a journal bearing and the second bearing may be a thrust bearing.

The damper portion may include a damper body engaged with the pulley portion, a hub connected to the crankshaft at the inside of the damper body, and a damping rubber that is disposed between the damper body and the hub.

The first bearing may be disposed between the interior circumference of the pulley portion and the exterior circumference of the damper body.

The second bearing may be engaged with the first bearing through protrusions and depressions of one end portion thereof to be disposed between an end portion of the pulley portion and the damper body.

In various aspects of the present invention, in contrast to conventional art, the first and second bearings of the bearing portion are engaged through the engagement grooves and the engagement protrusions without welding the first and second bearings or welding the second bearing to the pulley portion such that a welding process can be avoided in a manufacturing process of the entire damper pulley.

Accordingly, the manufacturing cost for the damper pulley may be reduced, the mounting quality of the bearing portion may be stabilized, the quality of the damper pulley may be improved, and resultantly the quality of the engine and the vehicle may be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an exploded perspective view showing an exemplary damper pulley for a vehicle according to the present invention.

FIG. 2 is a schematic diagram showing a joining structure of FIG. 1.

FIG. 3 is a cross-sectional view of a schematic diagram showing a joining structure of a bearing portion that is applied to an exemplary damper pulley for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Portions having no relation to the description will be omitted in order to explicitly explain the present invention, and the same reference numerals will be used for the same or similar elements throughout the specification.

In the drawings, the size and thickness of each element are approximately shown for better understanding and ease of description. Therefore, the present invention is not limited to the drawings, and the thicknesses of layers, films, panels, regions, etc., are exaggerated for clarity.

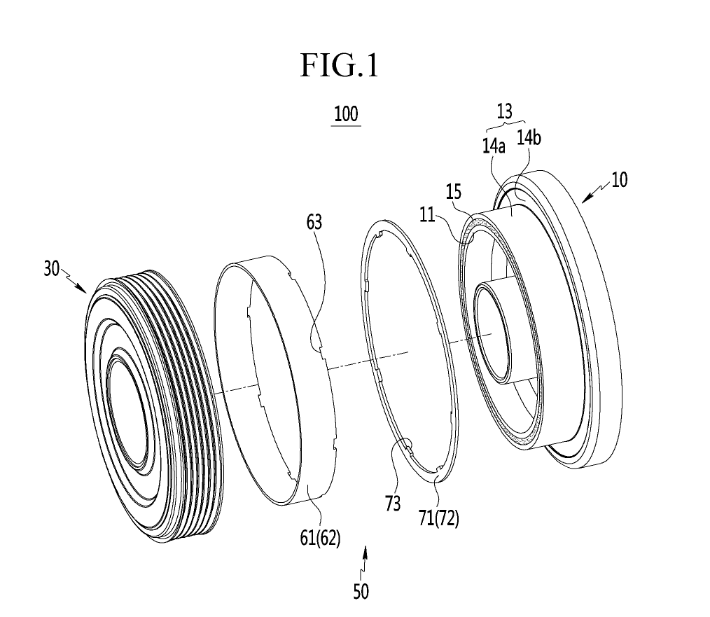

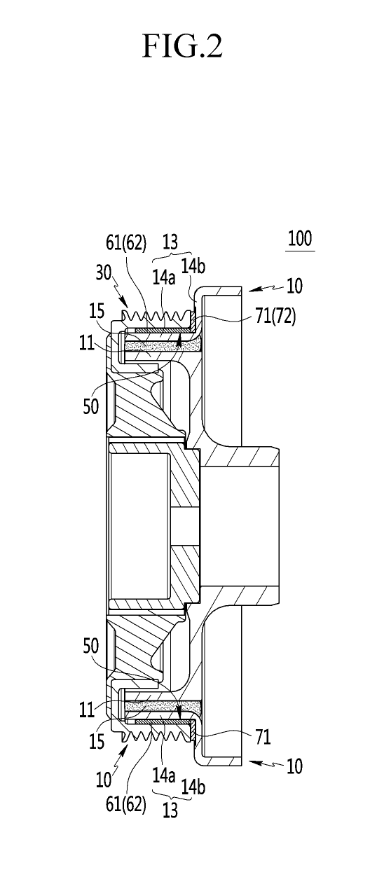

Referring to FIGS. 1 and 2, a damper pulley 100 for a vehicle according to various embodiments of the present invention can be applied to a power delivery system of a vehicle engine that can transfer power of an engine to a pulley.

For example, the power delivery system can transfer power to a water pump pulley, a power steering pulley, an alternator pulley, or an air-con pulley through a belt.

The damper pulley 100 reduces torsion vibration of a crankshaft, and decreases an angle speed variation of a rotation direction of a crankshaft that is formed during a combustion stroke in the combustion chamber of the engine.

The damper pulley 100 is connected to a crankshaft to be operated, and the engagement structure of the damper pulley 100 and the crankshaft is known to the public, so a detailed description thereof is omitted in this specification.

The damper pulley for vehicle 100 according to various embodiments is operated by the crankshaft, and the damper pulley is configured to omit the welding process in a manufacturing process of the entire damper pulley.

For this, the damper pulley for a vehicle 100 according to various embodiments of the present invention includes a damper portion 10, a pulley portion 30, and a bearing portion 50, and these are respectively described as follows.

The damper portion 10 reduces torsion vibration of a crankshaft and an angle speed variation of a crankshaft that is generated during a combustion stroke in the combustion chamber of the engine.

The damper portion 10 includes a hub 11 that is connected to the crankshaft, a damper body 13 that is substantially engaged with the hub 11 through the pulley portion 30 that is to be described hereafter, and a damping rubber 15 that is disposed between the damper body 13 and the hub 11.

The hub 11 is engaged with the pulley portion 30, the damper body 13 is forcibly fit into the pulley portion 30, and the damping rubber 15 is interposed between the hub 11 and the damper body 13.

For example, the damper body 13 includes a first part 14a that is forcibly fitted into the pulley portion 30 and a second part 14b that is integrally connected to the first part 14a, and the diameter thereof is greater than that of the first part 14a. One will appreciate that the first and second parts may be monolithically formed.

In this case, the damping rubber 15 can be interposed between the exterior circumference of the hub 11 and the interior circumference of the first part 14a and be attached to the exterior circumference and the interior circumference thereof. The damping rubber 15 reduces torsion vibration of the crankshaft and an angle speed variation of the crankshaft that is generated during a combustion stroke in the combustion chamber.

A belt is wound around the pulley portion 30 and is connected to the hub 11 of the damper portion 10 and the damper body 13. A pulley space is formed at an interior side of the pulley portion 30 to be engaged with a part of the hub 11 and the first part 14a of the damper body 13.

The bearing portion 50 is configured to prevent friction and noise between the damper portion 10 and the pulley portion 30 in various embodiments. The bearing portion 50 is disposed between the damper portion 10 and the pulley portion 30 to be forcibly fitted into the pulley portion 30 together with the damper portion 10.

The bearing portion 50 includes a first bearing 61 that supports a load applied in an axial direction, and a second bearing 71 that supports a load applied in a direction perpendicular to the axial direction in the damper pulley 100.

The first bearing 61 has a cylindrical shape with a predetermined length to be a type of a journal bearing made of a metal material. Further, the second bearing 71 is a type of a thrust bearing 72 having a flat circular ring shape.

The first bearing 61 is interposed between the interior circumference of the pulley portion 30 and the exterior circumference of the first part 14a in the damper body 13. The second bearing 71 is disposed between one end portion of the pulley portion 30 and the second part 14b in the damper body 13.

In the bearing portion 50 according to various embodiments of the present invention, the first and second bearings 61 and 71 are engaged through protrusions and depressions, in contrast to a conventional art, without welding the first and second bearings 61 and 71 or welding the second bearing 71 to the pulley portion 30.

That is, the first and second bearings 61 and 71 are configured to be assembled or separated from each other through the protrusion and depression structure.

As an example, the second bearing 71 is engaged with one end portion of the first bearing 61 through protrusions and depressions of a flange type, wherein the second bearing 71 is extended in a radial direction of the first bearing 61.

For this, a plurality of engagement protrusions 73 are formed along the circumference of the inner side of the second bearing 71. The engagement protrusions 73 are formed at a predetermined distance from each other.

A plurality of engagement grooves 63 are formed in one end portion of the first bearing 61, i.e., one end portion of the pulley portion 30, to be engaged with the engagement protrusions 73 of the second bearing 71.

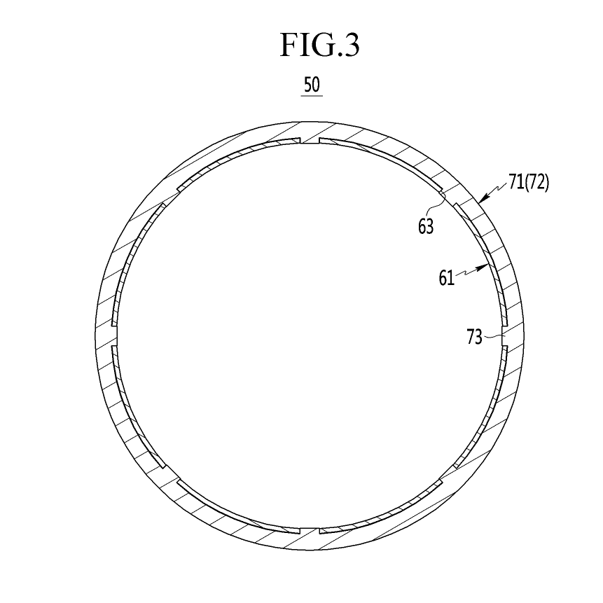

Accordingly, as described above, as shown in FIG. 3, the engagement protrusions 73 of the second bearing 71 are engaged with the engagement grooves 63 of the first bearing 61 to realize the bearing portion 50 in the damper pulley 100 for a vehicle according to various embodiments.

The bearing portion 50 is forcibly fitted into the pulley portion 30 together with the damper portion 10 to prevent friction and noise between the damper portion 10 and the pulley portion 30.

In this way, in the damper pulley 100 for a vehicle according to various embodiments of the present invention, the first and second bearings 61 and 71 of the bearing portion 50 are engaged through the engagement grooves 63 and the engagement protrusion 73 without welding the first and second bearings 61 and 71 of the bearing portion 50 or welding the second bearing 71 to the pulley portion 30 in contrast to a conventional art such that a welding process is avoided in a manufacturing process of the entire damper pulley 100.

Accordingly, the manufacturing cost for the damper pulley can be reduced, the mounting quality of the bearing portion is stabilized, the quality of the damper pulley is improved, and resultantly the quality of the engine and the vehicle is improved in various embodiments.

In various embodiments, grooves are formed in the first bearing 61, protrusions are formed in the second bearing 71, and the protrusions are engaged with the grooves to realize the bearing portion 50 in various embodiments. However, this invention is not limited thereto, i.e., the protrusions can be formed in the first bearing 61 and the grooves can be formed in the second bearing 71 to realize the bearing portion 50.

For convenience in explanation and accurate definition in the appended claims, the terms inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A damper pulley for a vehicle, comprising:
a damper portion for mounting on a crankshaft;
a pulley portion operably connected to the damper portion; and
a bearing portion disposed between the damper portion and the pulley portion;
wherein the bearing portion includes a first bearing for receiving a load applied in an axial direction and a second bearing for receiving a load applied in a direction perpendicular to the axial direction, and the first and second bearings are operably engaged through a plurality of protrusions and corresponding depressions.

2. The damper pulley for a vehicle of claim 1, wherein the first and second bearings are separable from each other.

3. The damper pulley for a vehicle of claim 1, wherein one of the first and second bearings is engaged with the other through said plurality of protrusions and corresponding depressions of having flange configuration.

4. The damper pulley for a vehicle of claim 1, wherein a plurality of engagement protrusions are formed on one of the first and second bearings along its circumference direction, and a plurality of engagement grooves are formed on the other of the first and second bearings.

5. The damper pulley for a vehicle of claim 1, wherein the bearing portion is press-fit into the pulley portion together with the damper portion.

6. The damper pulley for a vehicle of claim 1, wherein the first bearing has a cylinder shape having a predetermined width, and the second bearing has a band shape having a predetermined width.

7. The damper pulley for a vehicle of claim 6, wherein the second bearing is disposed outside the first bearing based on a concentric circle, and protrusions and depressions of the second bearing are engaged with one side end portion of the first bearing.

8. The damper pulley for a vehicle of claim 7, wherein a plurality of engagement protrusions are arranged at a predetermined distance from each other along an inner edge of the second bearing, and a plurality of engagement grooves are arranged along one side end portion of the first bearing to be engaged with the engagement protrusion.

9. The damper pulley for a vehicle of claim 1, wherein the first bearing is a journal bearing and the second bearing is a thrust bearing.

10. The damper pulley for a vehicle of claim 1, wherein the damper portion includes a damper body engaged with the pulley portion, a hub connected to the crankshaft at the inside of the damper body, and a damping rubber that is disposed between the damper body and the hub.

11. The damper pulley for a vehicle of claim 10, wherein the first bearing is disposed between the interior circumference of the pulley portion and the exterior circumference of the damper body; and
the second bearing is engaged with the first bearing through protrusions and depressions of one end portion thereof to be disposed between an end portion of the pulley portion and the damper body.
